(19) United States
(12) Patent Application Publication
(10) Pub. No.: US 2008/0091449 A1
(43) Pub. Date: Apr. 17, 2008

(54) Billboard postage stamps new place for financial market

(76) Inventor: Vladimir Naumenko, North Hollywood, CA (US)

Correspondence Address: Vladimir Naumenko, 5311 Corteen P.l #27, North Hollywood, CA, 91607, US

(21) Appl. No.: 11/603,385

(22) Filed: Jan. 16, 2007

Related U.S. Application Data
(60) Provisional application No. 60/852,094, filed on Oct. 16, 2006.

(51) Int. Cl. G06Q 10/00

(52) U.S. Cl. 705/1

(57) ABSTRACT

1. Postage Stamps, block postage stamps and/or roll postage stamps as a source of information consists of paper base 1 over such base is located area of billboard indicated as 2. In any of the corners of the inner area in which is located a symbol of index price 3, and in any other corner is located an indication of abbreviation of original country 4, also located in any of the corners telephone code of country 5. Area 4 displays a print of name of country(s), name of state(s) as a full name or as abbreviation. Area 5 displays printed telephone code of country, international dialing number. It must not interfere with areas 4 and 5. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.
2. Block postage stamps or roll postage stamps as a source of information consists of paper base 1, over such base include additional area billboard indicated as 6. Area 7 is located on the back side of block postage stamps or roll postage stamps. Areas 6 and 7 displays information, promotion(s), advertisement(s), name(s), logo(s), sale name(s), trademark(s), commercial inscription(s), contact information, photo(s), image(s), illustration art(s), any other type(s) of art or design.
3. Postage Stamps, block postage stamps and/or roll postage stamps, area 2 billboards areas 6 and 7 (displayed information) will be used as space of financial market which can be sold Governments through the financial global market.
4. Post Stamp, block post stamp and/or roll post stamp have billboards 2, have price bar code 3, area 6 and 7 contain bar code 8.
5. Design of post stamp used as source of information, used as billboards 2 to products of postal service through the print up of letters and envelops (print using printer which is used through network)

The invention relates to a business method, more specific, it relates to financial directions also it can give support to the postal service, use Forex exchange global market, Government develop the economy, and gives help to other Governmental purposes economical programs and licensed by.

Known business methods have deficiencies. Deficient support collection program postage stamps, weak support for development of manufacturing postage stamps, poor developments of affiliate companies that work with the postal service and daughter companies of the postal service, lack of stimulation for network program of the Forex exchange market and stocks.

Submitted is an example of a product relating to commercial exploitation of a postage stamps, and may be used on postcards, envelopes, packages, telegrams, any and all packages and postal letters and materials having to do with interstate and international postage. The postage stamps or block/roll used as source of information used as a billboard to advertise products and/or services through the post service.

Known analog is a source of information and presents not to be a postage stamp. Such sources of information are magazine and newspaper advertisements, promotions and notifications, advertisement sheets delivered by mail, television advertisements and promotions.

The following are prototypes examples of products that serve as postage stamps, postage stamp block and/or postage stamp roll which do not have elements of a commercial or advertising, promotion, notification purpose and is not a source of commercial information, no stamps display logos, phone digital codes, organizations or associations that exist primary to solicit or distribute funds, commercial enterprises or products, cities, towns, municipalities, countries, primary or secondary schools, hospitals, or similar institutions, religious institutions, any subject that has been issued in the past ten years.

### (Shown Current Examples That are not Commercial in Nature)

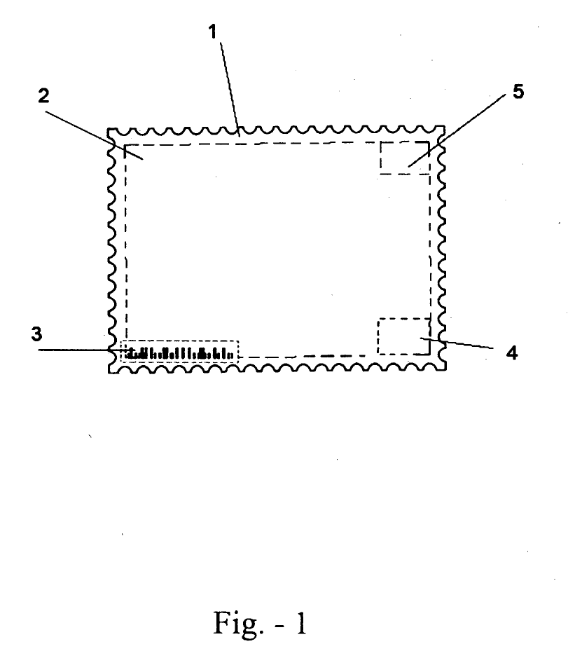

FIG. 1. is an illustration of enlarged plan of view consistency of rectangular postage stamp.

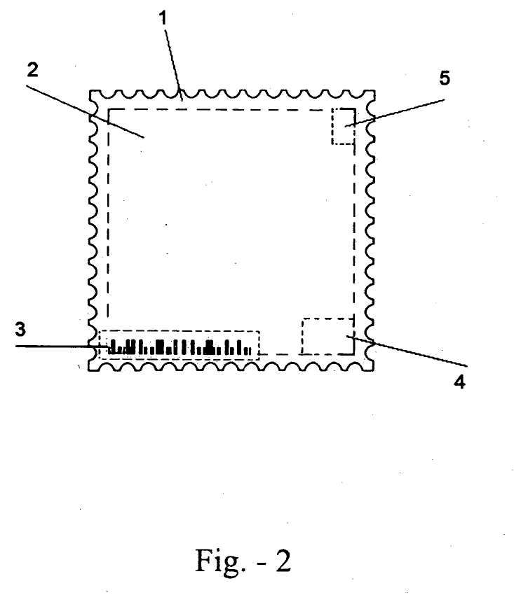

FIG. 2. is an illustration of enlarged plan of view consistency of square postage stamp.

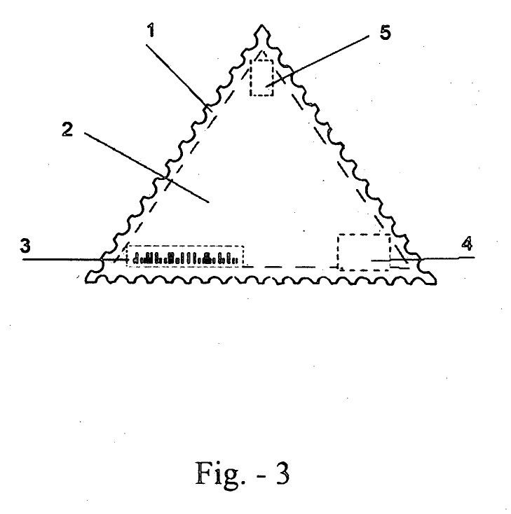

FIG. 3. is an illustration of enlarged plan of view consistency of triangular postage stamp.

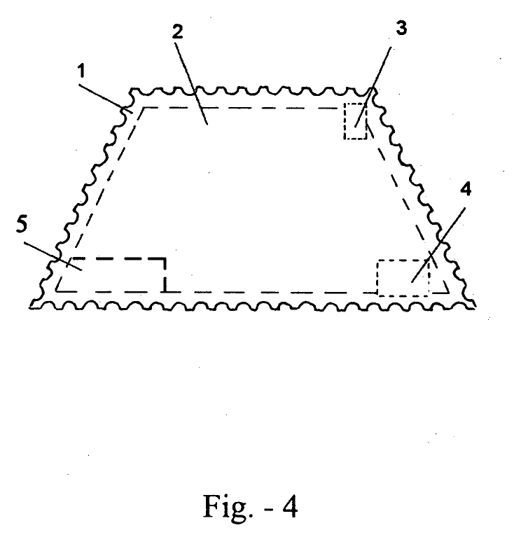

FIG. 4. is an illustration of enlarged plan of view consistency of trapezoidal postage stamp.

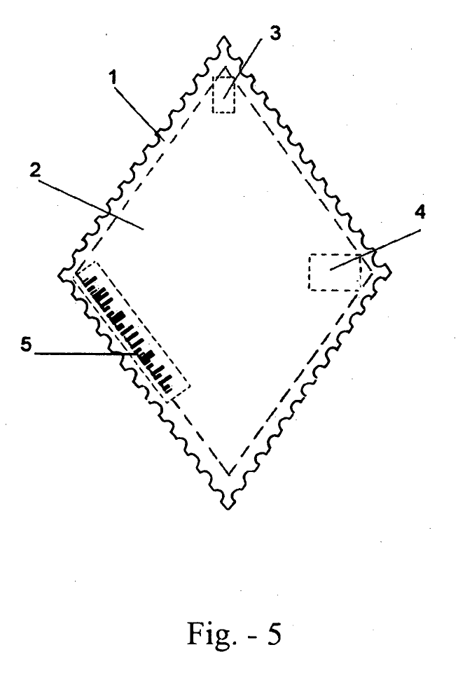

FIG. 5. is an illustration of enlarged plan of view consistency of rhomboid postage stamp.

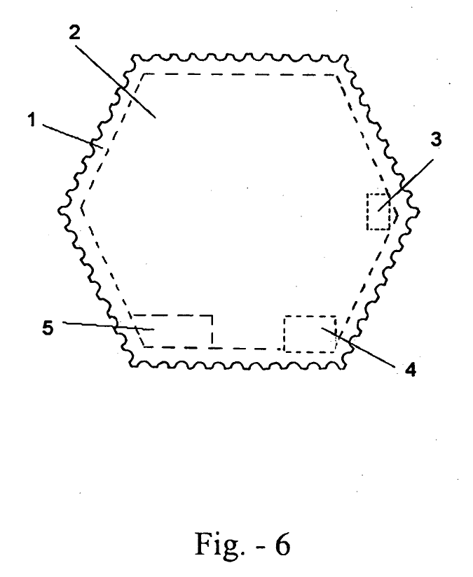

FIG. 6. is an illustration of enlarged plan of view consistency of hexagonal (6 sided) postage stamp.

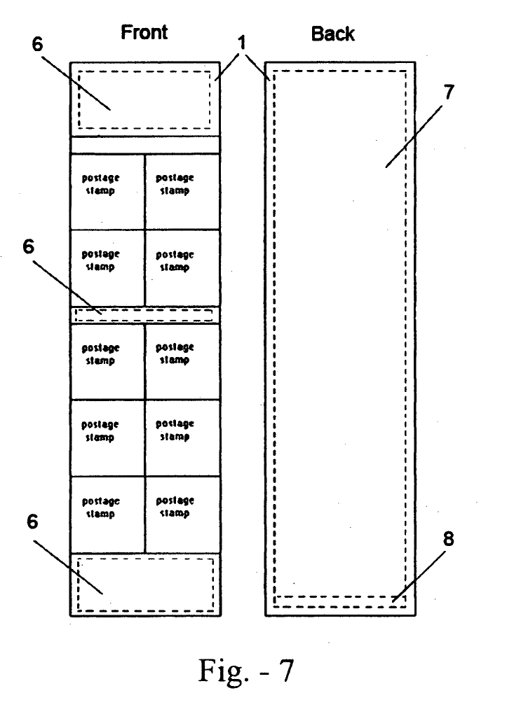

FIG. 7. is an illustration of enlarged plan of view consistency of block of postage stamps and rolls postage stamp.

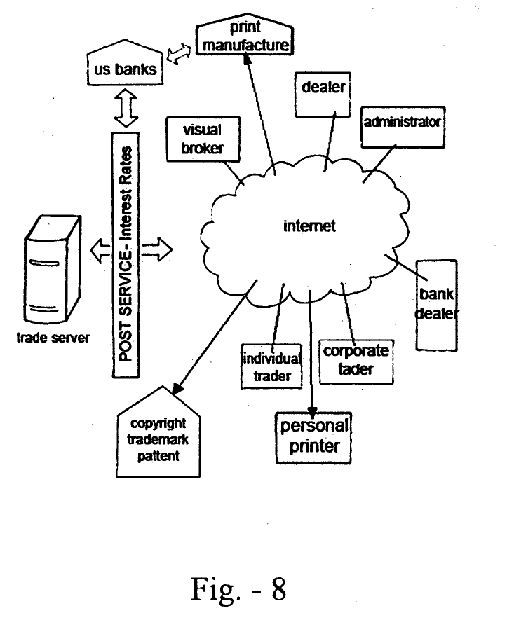

FIG. 8. displays a diagram of a plan of the financial market.

Postage Stamps, block postage stamps and/or roll postage stamps as a source of information consists of paper base 1 over such base is located area of billboard indicated as 2. In any of the corners of the inner area in which is located a symbol of price 3, and in any other corner is located an indication of a country 4, also located in any of the corners telephone code of country 5. Area 4 displays a print of name of country(s), name of state(s) as a full name or as abbreviation. Area 5 displays printed telephone code of country, international dialing number. It must not interfere with areas 4 and 5. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design. Block postage stamps or roll postage stamps as a source of information consists of paper base 1, over such base include additional area billboard indicated as 6. Area 7 is located on the back side of block postage stamps or roll postage stamps. Areas 6, 7 and 8 (bar code) displays information, promotion(s), advertisement(s), name(s), logo(s), sale name(s), trademark(s), commercial inscription(s), contact information, photo(s), image(s), illustration art(s), any other type(s) of art or design.

The submitted invention may easily be produced at current technology level.

Rectangular postage stamps as a source of information consists of paper base 1 over such base is located area of billboard indicated as 2. In any of the corners of the inner area in which is located a 3 executed as either a symbol or bar code, in any other corner is located an indication of an abbreviation of country or state 4. Area 4 displays a print of name of country(s), name of state(s) as a full name or as abbreviation. Also located in any of the corners telephone code of country 5. Area 5 displays printed telephone code of country, international dialing number. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.

Area 2 is not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.

Square postage stamps as a source of information consists of paper base 1 over such base is located area of billboard indicated as 2. In any of the corners of the inner area in which is located a 3 executed as either a symbol or bar code, in any other corner is located an indication of an abbreviation of country or state 4. Area 4 displays a print of name of country(s), name of state(s) as a full name or as abbreviation. Also located in any of the corners telephone code of country 5. Area 5 displays printed telephone code of country, international dialing number. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.

Area 2 is not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.

Triangular postage stamps as a source of information consists of paper base 1 over such base is located area of billboard indicated as 2. In any of the corners of the inner area in which is located a 3 executed as either a symbol or bar code, in any other corner is located an indication of an abbreviation of country or state 4. Area 4 displays a print of name of country(s), name of state(s) as a full name or as abbreviation. Also located in any of the corners telephone code of country 5. Area 5 displays printed telephone code of country, international dialing number. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.

Area 2 is not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.

Trapezoidal postage stamps as a source of information consists of paper base 1 over such base is located area of billboard indicated as 2. In any of the corners of the inner area in which is located a 3 executed as either a symbol or bar code, in any other corner is located an indication of an abbreviation of country or state 4. Area 4 displays a print of name of country(s), name of state(s) as a full name or as abbreviation. Also located in any of the corners telephone code of country 5. Area 5 displays printed telephone code of country, international dialing number. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.

Area 2 is not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.

Rhomboid postage stamps as a source of information consists of paper base 1 over such base is located area of billboard indicated as 2. In any of the corners of the inner area in which is located a 3 executed as either a symbol or bar code, in any other corner is located an indication of an abbreviation of country or state 4. Area 4 displays a print of name of country(s), name of state(s) as a full name or as abbreviation. Also located in any of the corners telephone code of country 5. Area 5 displays printed telephone code of country, international dialing number. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.

Area 2 is not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.

Hexagonal (6-sided) postage stamps as a source of information consists of paper base 1 over such base is located area of billboard indicated as 2. In any of the corners of the inner area in which is located a 3 executed as either a symbol or bar code, in any other corner is located an indication of an abbreviation of country or state 4. Area 4 displays a print of name of country(s), name of state(s) as a full name or as abbreviation. Also located in any of the corners telephone code of country 5. Area 5 displays printed telephone code of country, international dialing number. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.

Area 2 is not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.

Even better area 2 billboards would be used on postage stamp blocks and rolls billboards 6 and 7. Or on the revers sides or next to the postage stamps. A block of postage stamps and rolls is put on an advertisement sheet that is sold at the post stamp or the back of the stamp block. Such an advertisement sheet can be used to advertise all kinds of businesses institutions as well as it can be used for educational purposes. Name, and/or logo, and/or/sale name, and/or commercial inscioption, and address of selling firm, telephone number, electronic address, photo, fax, and telex numbers maybe inscripted. The letter are including, but not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.

Design of post stamp used as source of information, used as billboards 2 to products of postal service through the print up of letters and envelops (print using printer which is used through network).

The invention will be used to also improve effectiveness of economics. Postage Stamps, block postage stamps and/or roll postage stamps, area 2 billboards areas 6 and 7 (displayed information) will be used as space of financial market which can be sold Governments through the financial global market.

All of the active economic company's that can not afford the privilege of having there displays information, promotion(s), advertisement(s), name(s), logo(s), sale name(s), trademark(s), commercial inscription(s), contact information, photo(s), image(s), illustration art(s), any other type(s) of art or design put on a postage stamp may put there logo on the revise side or next to the stamp block.

The submitted invention may easily be produced at current technology levels and commercial standards, using current technology and manufacturing processes. Such invention will bring high effectiveness:

will bring needed information to consumers.

will give opportunity for support of collection programs of postage stamps

will support daughter companies associated with post service.

will stimulate network program of the Forex exchange market and stocks.

will give better support to the postal service.

will relate to the Government economy

will give purposes to economical programs

will give opportunity to support economic zone for governments.

will become a new market of postal service.

1. The invention relates to a business method, more specific, it relates to financial directions also it can give support to the postal service, use Forex exchange global market, Government develop the economy, and gives help to other Governmental purposes economical programs.
Given name Billboards Postage Stamps, block postage stamps and/or roll postage stamps as a source of information consists of paper base 1 over such base is located area of billboard indicated as 2. In any of the corners of the inner area in which is located a symbol of price 3, and in any other corner is located an indication of a country 4, also located in any of the corners telephone code of country 5. Area 4 displays a print of name of country(s), name of state(s) as a full name or as abbreviation. Area 5 displays printed telephone code of country, international dialing number. It must not interfere with areas 4 and 5. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design. Block postage stamps or roll postage stamps as a source of information consists of paper base 1, over such base include additional area billboard indicated as 6. Area 7 is located on the back side of block postage stamps or roll postage stamps. Areas 6, 7 and 8 (bar code) displays information, promotion(s), advertisement(s), name(s), logo(s), sale name(s), trademark(s), commercial inscription(s), contact information, photo(s), image(s), illustration art(s), any other type(s) of art or design.
A number selected by the user selects the proper abbreviation. A digital code 5 is selected that picks out the right abbreviation for a country 4, and vice versa. Best usage for this concept possible by software.
Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.
Area 2 is not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.
Even better area 2 billboards would be used on postage stamp blocks and rolls billboards 6 and 7. Or on the revers sides or next to the postage stamps. A block of postage stamps and rolls is put on an advertisement sheet that is sold at the post stamp or the back of the stamp block. Such an advertisement sheet can be used to advertise all kinds of businesses institutions as well as it can be used for educational purposes. Name, and/or logo, and/or/sale name, and/or commercial inscription, and address of selling firm, telephone number, electronic address, photo, fax, and telex numbers maybe in scripted. The letter are including, but not limited to: firms, banks, finance groups, commercial groups, organizations for profit, non-profit organizations, schools, universities, selling associations, corporations, religious organizations, selling concerns, filial s, insurance companies, trust and estate companies and groups, sporting organizations and clubs, television and radio companies, any and all economic and non-economic concerns and organizations, any insurance, any business place, investment group, credit group or and credit club, that are involved in any economic activity, for profit, charity, good will, trust, or otherwise.
Design of post stamp used as source of information, used as billboards 2 to products of postal service through the print up of letters and envelops (print using printer which is used through network).
The invention will be used to also improve effectiveness of economics. Postage Stamps, block postage stamps and/or roll postage stamps, area 2 billboards areas 6 and 7 (displayed information) will be used as space of financial market which can be sold Governments through the financial global market.
All of the active economic company's that can not afford the privilege of having there displays information, promotion(s), advertisement(s), name(s), logo(s), sale name(s), trademark(s), commercial inscription(s), contact information, photo(s), image(s), illustration art(s), any other type(s) of art or design put on a postage stamp may put there logo on the revise side or next to the stamp block.
Postage Stamps, block postage stamps and/or roll postage stamps as a source of information consists of paper base 1 over such base is located area of billboard indicated as 2. In any of the corners of the inner area in which is located a symbol of index price 3, and in any other corner is located an indication of abbreviation of original country 4, also located in any of the corners telephone code of country 5. Area 4 displays a print of name of country(s), name of state(s) as a full name or as abbreviation. Area 5 displays printed telephone code of country, international dialing number. It must not interfere with areas 4 and 5. Area 2 billboard indicated with a dotted line between corners of the stamp. Area 2 displays information, promotion(s), advertisement(s), name(s), logo(s), sale name(s), trademark(s), commercial inscription(s), contact information, photo(s), image(s), illustration art(s), any other type(s) of art or design.
Block postage stamps or roll postage stamps as a source of information consists of paper base 1, over such base include additional area billboard indicated as 6. Area 7 is located on the back side of block postage stamps or roll postage stamps. Areas 6 and 7 displays information, promotion(s), advertisement(s), name(s), logo(s), sale name(s), trademark(s), commercial inscription(s), contact information, photo(s), image(s), illustration art(s), any other type(s) of art or design.
Postage Stamps, block postage stamps and/or roll postage stamps area 2 billboards areas 6 and 7 (displayed information) will be used as space of financial market which can be sold Governments through the financial global market.
Post Stamp, block post stamp and/or roll post stamp have billboards 2, have price bar code 3, area 6 and 7 contain bar code 8.
Design of post stamp used as source of information, used as billboards 2 to products of postal service through the print up of letters and envelops (print using printer which is used through network).
